(19) United States
(12) Patent Application Publication
(10) Pub. No.: US 2016/0236116 A1
(43) Pub. Date: Aug. 18, 2016

(54) HINGED LAUNDER COVER SYSTEM FOR IMPROVED ACCESS TO THE WEIR

(71) Applicant: Earle Schaller, Palm Beach Gardens, FL (US)

(72) Inventor: Earle Schaller, Palm Beach Gardens, FL (US)

(21) Appl. No.: 14/623,078

(22) Filed: Feb. 16, 2015

(51) Int. Cl. B01D 21/24; B01D 21/00; E03F 5/14

(52) U.S. Cl. CPC B01D 21/2433; E03F 5/14; B01D 21/0003

(57) ABSTRACT

A waste treatment tank cover arrangement is provided having at least one cover module having a cover section, a mounting section, and a hinge, where the cover section is pivotably mounted to the mounting section, movable between a dosed position and an open position. At least one cover module mounting bracket arrangement has a first L-shaped bracket connected to an inner side of a launder channel wall and a U-shaped mounting bracket conned to the first L-shaped bracket and extending upward, where the U-shaped mounting bracket connects to and supports the mounting section of the cover module. The position of the mounting bracket and connected hinge are such that the position of the hinge is inboard relative to the location of the weir such that when the cover section is in an open position, the weir is exposed and not hidden beneath the mounting section.

### BACKGROUND

1. Field of the Invention

The present arrangement is directed to a waste treatment tank launder cover arrangement. More particularly, the present arrangement is directed to a cover and associated mounting arrangement for a launder channel cover.

2. Description of Related Art

The primary and secondary clarifiers in most wastewater treatment plants are large circular tanks designed to allow solids to settle out of the sewage influent and collect the clean water in an effluent channel, or launder channel, built around the periphery at the top of the clarifier. This water is further processed before being returned to the environment.

Algae is a major nuisance that often forms in the nutrient rich effluent that collects in and around the clarifier launder channel. A weir is a common component of such launder channels, acting to control the flow of clean water into the launder and further assisting in preventing solids that have not settled from entering the launder channel. The algae often collects on the weir and launder surfaces, impacting hydraulic flow over the weir and passing downstream throughout the plant to clog filters and other equipment. Cleaning algae from the launder surfaces is an expensive, labor-intensive chore in treatment plants.

One of the most effective means of reducing or eliminating algae growth is the installation of a cover system that extends over the launder and weir and keeps incident sunlight from reaching the surfaces of the launder and weir, thus inhibiting the growth of the algae.

Prior art launder cover systems for algae control as shown for example in prior art FIG. 1 typically have a series of two-piece cover modules each made up of a mounting section and a cover section connected by a continuous stainless steel hinge. The mounting section is supported by a bracket that fastens to the top of the weir wall and serves as the base for the hinged cover section. The cover section is configured to be opened toward the center of the tank and away from the operator standing on the outer tank wall to allow the operator to clean the weir with a hose and inspect the weir and launder for algae growth, debris, wear and other factors that can affect effluent system performance. Principal among these factors is the collection of rags and other debris that can become entangled in the V-notched “teeth” of the weft and impact hydraulic flow in the clarifier.

A major concern among users of this design is the fact that, depending upon the viewing angle of the operator, the hinge point of the cover is in front of the weir plate and can, and often does, block the operator's view of the weir and his ability to dean the weir with a hose or brush if required. In other words the hinge is located closer to the outer tank wall than the weir as shown in FIG. 1.

### OBJECTS AND SUMMARY

The present arrangement overcomes the drawbacks by producing a novel cover mounting bracket arrangement for the mounting section of the cover module that is attached to the inner face of the weir wall so that the hinge point of the cover section can be moved inward towards the center of the tank relative to the prior art location so that it is between the weir and scum baffle. When the cover section is opened the weir is clearly visible from the tank wall and above without interference from the hinge area of the cover section.

To this end a waste treatment tank cover arrangement is provided having at least one cover module having a cover section, a mounting section, and a hinge, where the cover section is pivotably mounted to the mounting section, movable between a dosed position and an open position. At least one cover module mounting bracket arrangement has a first L-shaped bracket connected to an inner side of a launder channel wall and a U-shaped mounting bracket conned to the first L-shaped bracket and extending upward, where the U-shaped mounting bracket connects to and supports the mounting section of the cover module. The position of the mounting bracket and connected hinge are such that the position of the hinge is inboard relative to the location of the weir such that when the cover section is in an open position, the weir is exposed and not hidden beneath the mounting section.

### BRIEF DESCRIPTION OF THE DRAWINGS

The present invention can be best understood through the following description and accompanying drawings, wherein:

FIG. 1 is a prior art cut-away view of a launder channel and cover module;

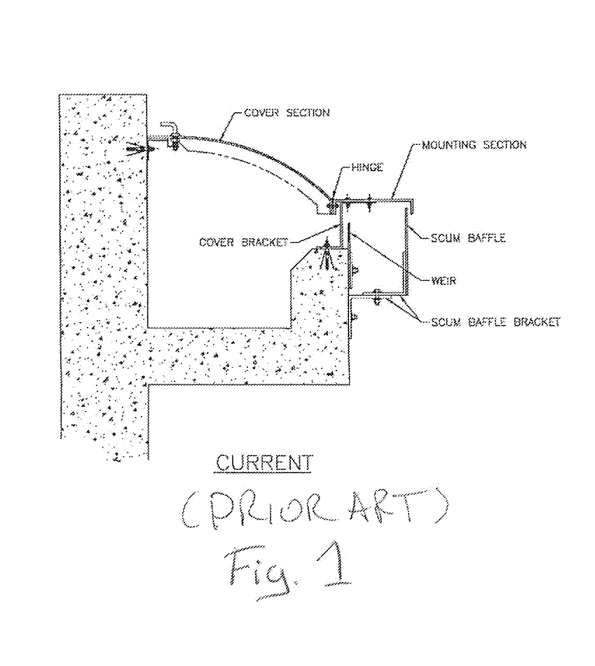

FIG. 2 shows a launder channel with a cover module mounting bracket arrangement in accordance with one embodiment;

FIG. 3 shows a launder channel with scum baffle and scum baffle bracket arrangement in accordance with one embodiment; and

FIG. 4 shows a launder channel with a cover module mounting bracket of FIG. 2 and scum baffle bracket arrangement of FIG. 3 in accordance with one embodiment.

### DETAILED DESCRIPTION

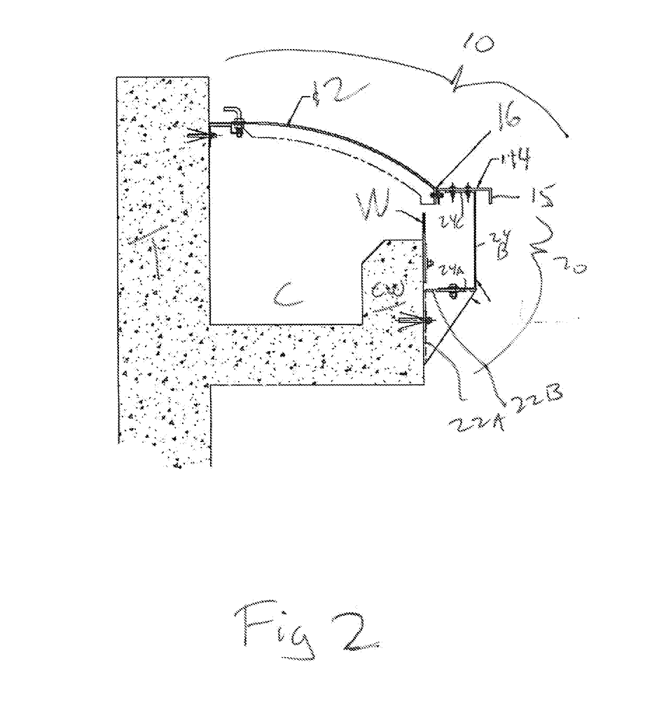

In accordance with one embodiment of the present arrangement, FIG. 2 shows a typical cross section of a clarifier tank in the area of a launder channel. As shown, the clarifier tank has an outer tank wall T, a launder channel C and a launder channel inner wall CW. At the top of channel wall CW is a weir W. For the purposes of illustrating the salient features of the invention, it is assumed that the clarifier tank is a typical circular clarifier tank with a launder channel located at the upper outer circumference however the features of the present cover module mounting bracket arrangement may be implemented on other shaped launder channels and clarifier tanks.

As shown in FIG. 2 a cover module 10 includes a cover section 12 and a mounting section 14 connected by a hinge 16. FIG. 2 shows cover module 10 in a closed position with the edge of cover module 12 resting against outer tank wall T. Cover section 12 is configured to be pivitoable about hinge 16 towards the center of the tank exposing the launder channel C and the weir W. Cover module 10 is typically constructed of molded fiber glass components with hinge 16 being made from metal. FIG. 2 is a cut-away view of a circular clarifier tank and launder channel but it is understood that a typical tank will have many independently mounted cover modules 10 each about three (3) to four (4) feet in length of an arcuate shape so that the combination of cover modules 10 in totality completely cover the entire launder channel C.

As shown in FIG. 2, a cover module mounting bracket arrangement 20 is provided for supporting the other side of cover module 10 at the launder channel wall. Cover module mounting bracket arrangement 20 is made from a first L-shaped bracket 22 with its first side 22A mounted flush against the inner side of the channel wall CW with the second side 22B of the L-shaped bracket 22 extending inward perpendicular to the inner side of the channel wall CW for a given distance. Attached to second side 22B of the L-shaped bracket is a U-shaped mounting bracket 24 with a first lower leg 24A attached to second side 22B of the L-shaped bracket, an upwardly extending leg 24B and another perpendicular upper leg 24C that is coupled to the underside of mounting portion 14 as shown in FIG. 2.

As shown in FIG. 2 owing to the extension of L-shaped bracket 22 and lower and upper legs 24A and 24C, hinge 16 between cover section 12 and mounting section 14 is positioned inward with respect to weir W so that when cover section 12 is opened an operator standing on tank wall T would have a clear un-obstructed view of weir W. As shown in FIG. 2, the connection between the second side 22B of the L-shaped bracket 22 and lower leg 24A of cover mounting bracket 24 as well as the connection between upper leg 24C of cover mounting bracket 24 and the underside of mounting section 14 are slidingly adjustable via bolt attachments 28 so to accommodate varying weir W locations so that hinge 16 is always inboard with respect thereto.

FIG. 2 shows a single cover mounting bracket 24 however it is understood that a number of such brackets 24 are disposed about the entire circumference of launder channel wall CW. In one example, each mounting section 14 is supported by two independent brackets 24 spaced apart from one another by a few feet along the circumference of launder channel wall 24. More or less brackets 24 may be used per mounting section 14 as desired based on the size of cover modules 10 and the size of the clarifier tank.

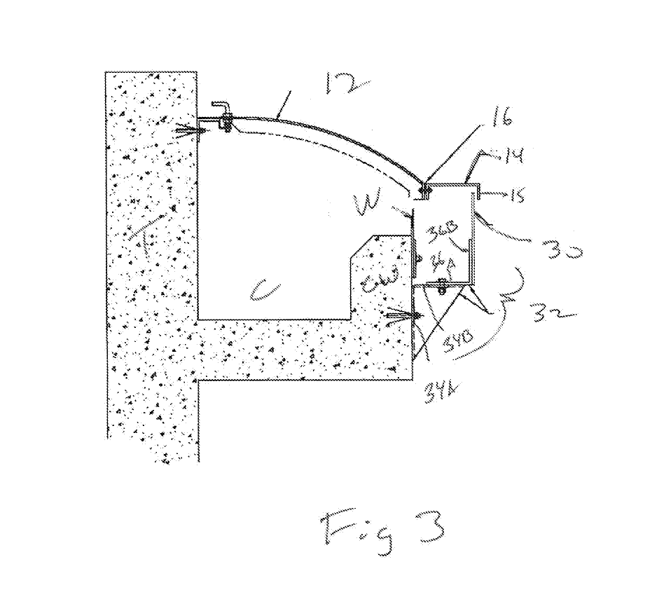

To prevent confusion, FIG. 3 separately illustrates a side view of a scum baffle 30 and scum baffle mounting bracket arrangement 32 with the mounting brackets 24 removed for clarity. A scum baffle is used to prevent solids from passing in launder channel C. Scum baffle bracket arrangement 32, has a first L-shaped bracket 34 similar to L-shaped bracket 22 above, with a lower portion 34A attached to the inner side of launder channel wall CW and a perpendicular portion 34B extending inward. Attached to first L-shaped bracket 34 is a second L-shaped bracket 36 which likewise has a first perpendicular portion 36A and then an upwardly extending portion 363. The actual scum baffle 30 is attached to upwardly extending portion 36B up towards mounting section 14. As shown in FIG. 3, the top of baffle 30 extends upwards far enough to end just below the underside of mounting section and nested within a downturned flange 15 of mounting section 14 so as to essentially prevent all sunlight from reaching weir W.

As with FIG. 2, to be understood clearly, FIG. 3 shows a single scum baffle 30 and bracket arrangement 32 however it is understood that a number of such baffles 30 and brackets 32 are disposed about the entire circumference of launder channel wall CW. In one example, the actual “baffle” is comprised of a plurality of baffles 30, each arcuate in shape and extending around the entire inner circumference of launder channel wall CW. In one example, each section of baffle 30 may be supported by two independent brackets 32 spaced apart from one another by a few feet along the circumference of launder channel wall 24, potentially interspersed between cover module brackets 24, As with brackets 24, more or less brackets 32 may be used per baffle 30 as desired based on the size of each component baffle 30 and the size of the clarifier tank.

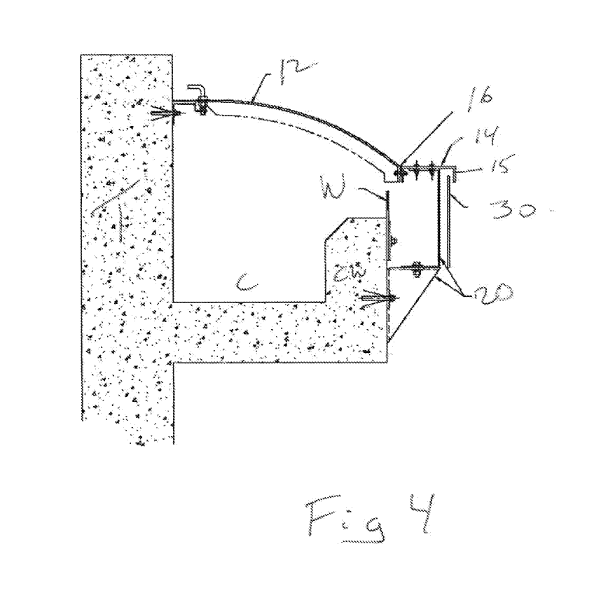

The final FIG. 4, shows the combination of cover module mounting bracket 24 with scum baffle 30 (baffle brackets remove) so that the position relationship between the two can be seen.

In another embodiment, it is noted that an alternative arrangement for the mounting of scum baffle 30 (not shown) could include mounting scum baffle 30 to mounting section 14, and/or putting a strap between the mounting section 14 and the scum baffle 30.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A waste treatment tank cover arrangement for a launder channel and weir, said cover arrangement comprising:
at least one cover module having,
a cover section,
a mounting section, and
a hinge, wherein said cover section is pivotably mounted to said mounting section by said hinge, movable between a closed position covering said launder channel and an open position exposing said launder channel and said weir;
at least one cover module mounting bracket arrangement having
a first L-shaped bracket connected to an inner side of a launder channel wall, and
a U-shaped mounting bracket connected to said first L-shaped bracket and extending upward,
wherein said U-shaped mounting bracket connects to and supports said mounting section of said cover module and
wherein said position of said mounting bracket and connected hinge are such that the position of said hinge is inboard relative to the location of said weir such that when said cover section is in an open position, said weir is exposed and not hidden beneath said mounting section.

2. The waste treatment tank cover arrangement as claimed in claim 1, wherein said waste treatment tank cover arrangement includes a plurality of said cover modules, each of arcuate shape surrounding and covering said entire launder channel.

3. The waste treatment tank cover arrangement as claimed in claim 1, wherein said cover section and said mounting section are made from molded fiberglass.

4. The waste treatment tank cover arrangement as claimed in claim 1, wherein said L-shaped bracket has a first side mounted flush against said inner side of said launder channel wall and a second side extending inward perpendicular to said inner side of said launder channel wall.

5. The waste treatment tank cover arrangement as claimed in claim 4, wherein said U-shaped mounting bracket has a first lower leg attached to said second side of said L-shaped bracket;
an upwardly extending leg; and
and a perpendicular upper leg coupled to the underside of said mounting portion.

6. The waste treatment tank cover arrangement as claimed in claim 5, wherein a connection between said second side of said L-shaped bracket and said lower leg of said cover mounting bracket, as well as a connection between said upper leg of said cover mounting bracket and said underside of said mounting section are slidingly adjustable via bolt attachments.

7. The waste treatment tank cover arrangement as claimed in claim 1, further comprising a scum baffle.

8. The waste treatment tank cover arrangement as claimed in claim 7, wherein said scum baffle is made from a plurality of baffles, each arcuate in shape and extending around an entire inner circumference of said launder channel wall.

9. The waste treatment tank cover arrangement as claimed in claim 8, wherein each of said baffles are supported by two independent brackets spaced apart from one another along said inner circumference of said launder channel wall.
